(19) United States
(12) Patent Application Publication
(10) Pub. No.: US 2012/0072501 A1
(43) Pub. Date: Mar. 22, 2012

(54) System and Method Providing Universal Addressing in Digital Communication Systems

(76) Inventor: Shaoul Amar, Los Angeles, CA (US)

(21) Appl. No.: 12/885,159

(22) Filed: Sep. 17, 2010

(51) Int. Cl. G06F 15/16; G06F 17/30

(52) U.S. Cl. 709/206; 707/609; 709/223; 707/E17.005

(57) ABSTRACT

A system, method and computer program product providing a universal naming system.

### BACKGROUND AND SUMMARY

The present invention relates generally to methods, systems, and a computer program for creating and maintaining a universal address system for digital communication systems. The advent of the Internet has created an unprecedented network for digital communication for voice, video, and images that covers the globe and has interconnected literally billions of people. While initially a network for stationary computers in offices and homes it has evolved into a network that provides connectivity for a wide variety of mobile digital devices. It provides access to the Worldwide Web for searching and locating information, email transmission and more recently social networks such as Facebook, Twitter and the like. Underlying all of this connectivity is a sophisticated protocol, TCP/IP, and hierarchical addressing system as will be explained below.

In parallel, the telephone system has provided voice connectivity for over a century. This system has also evolved from early manual switching of stationary telephones connected to a local central office by copper wire cables and pairs from an office or residence. Progressing through mechanical switches to electronic switching systems point-to-point connectivity facilitated voice communication to the point where in the United States nearly every home was equipped with a telephone. Within recent memory the cell phone became ubiquitous as wireless connectivity was made widely available through large telephone network operators such as AT&T, Verizon, and the like. From early on the system users were trained to obtain, record, maintain, and communicate their home or office telephone number. The telephone addressing scheme went through many transitions as the number of addresses (telephone numbers) multiplied into the hundreds of millions worldwide. Underlying this addressing scheme was a hierarchical architecture used in most countries; in the United States—a unique four-digit number is assigned by the telephone company to a specific voice instrument, a three digit prefix for a local geographic zone, like your neighborhood or town, and a three digit area code that covers sections of the entire country. An additional three digits were assigned to countries throughout the world, each country having its own addressing scheme generally in a hierarchical structure similar to that described above.

The result is that users of the Internet and telephone networks have two numbers, or in the case of the Internet a domain name, the numbers used to communicate using one or the other of the systems. In a world where a typical adult has a driver's license number, a social security number, perhaps a military identification number, one or more credit card numbers each with its own security number “on the back”, an employee badge number, a PIN for access to certain accounts, multiple passwords to sign on to various computers, networks, online entities, automobile door access codes, alarm system codes for homes and offices, online merchants' passwords and customer numbers, frequent flyer or buyer numbers, and countless other numbers, it is understandable that any simplification of the primary communication tools—the Internet and the telephone (cell phone)−would be welcome. The present invention disclosed in the exemplary embodiment described herein of a universal addressing system and method achieves that simplification.

### Terminology

The term “user” includes a person, a group of persons, a business entity, an organization or any other entity that has some common interest in sharing information.

While background information for the invention is described in connection with the Internet Protocol (IP) and Transmission Control Protocol (TCP), it will be understood that the exemplary embodiment of the invention may use other protocols such as the User Datagram Protocol (UDP), a protocol used in many Voice over IP (VoIP) applications and considered a “connectionless” service since it does not perform any error-checking. Real-Time Transport Protocol (RTP) is also used with VoIP; including RTCP (Real-Time Control Protocol). These and other VoIP protocols are discussed below. There are also several router protocols that affect the described embodiment of the invention, such as the protocol called Border Gateway Protocol (BGP) that is a common protocol used on the Internet running over TCP.

The term “network” is a general term that means two or more devices or services, or networks that can communicate over wire or wireless to share information. The term Internet, with a capital “I” refers to the network that is a worldwide collection of devices, services and networks that uses the TCP/IP protocol or suite of protocols including certain services and applications. The term “internet” may be any network but is used here to mean a private network. A private network as used here may also be an “intranet,” a network on a single geographical site, or an “extranet” sometimes referred to as a “virtual private network” (VPN). The latter is a term used to mean a network that may be wide in geographic scope but is controlled by a single private entity and may use public facilities. It is to be understood that whether public, like the Internet, or private like a multinational company VPN, the network may employ TCP/IP as the protocol suite and/or UDP that may be used to support VoIP.

The term “LAN” refers to a local network, such as within a single residence or office, connected by wires and cables; WLAN refers to the same size network but using wireless communication.

The word “domain” is defined in RFC 1518 to mean a group of resources under control of a single administration. An “ISP”, Internet Service Provider, is a domain of domains, in other words the subscribers are domains rather than hosts.

The term “mobile device” includes a Personal Digital Assistant (PDA), a palmtop computer, a hand-held computer, a laptop computer, a tablet or notebook computer, an e-reader such as Kindel, a GPS navigation device, an MP3 or other audio player, a pager, a wristwatch or other timepiece, a camera, a portable game player, or any other portable information processing device configured or capable of being configured for communication over a network.

The word “server” means a computer or other processing element capable of being configured for the storage, maintenance, delivery and processing of information received or transmitted over the Internet or other network.

The term “mobile site” may include a website, a collaborative workspace, a data mailbox, a collaborative community, an Internet storefront, M-Channels (mechanisms for communication between management embedded in hardware, virtual machines, and in applications), an associated data set, or other similar elements, including portions or combinations thereof. The “mobile site” may comprise a group having multiple members with a common interest. Examples include, a family, a group of friends, a club, a sports team, a business, a sales force, a civic group, a fan group, a political party, charity, or other type of multi-member organization. The “mobile site” may be used for disseminating information by generating messages, such as Instant Messaging (IM) or Multimedia Messaging (MM) that allows the user to send, receive, and browse multimedia-based messages (in audio, text, image, and video formats), web pages, emails, VoIP calls, cellular telephone calls or any other suitable messaging format.

### Some System Background

Many users of the Internet have heard the term TCP/IP, a so-called protocol suite or stack that is responsible for creating and maintaining a communication path between two or more devices. While a basic understanding of the entire suite is helpful to understand the present invention, the process of naming and addressing takes place in the application layer of the suite providing domain name service because that is where the address naming and connection information is defined. Every device that is connected to the Internet, has a unique address that is used by the IP to send and receive messages. IP or UDP are the data movers between two devices on the Internet. Initially, there was a version of IP widely used, and still used in some networks, called IPv4, that is, version 4 of the IP protocol. As the Internet expanded, it was found that IPv4 provided too few addresses (and had certain security issues); the IAB therefore developed and implemented IPv6, a more robust protocol. IP (either version) includes a protocol and service called Address Resolution Protocol (ARP) that functions to relate an IP address to the address of the device that is connected to the network. Every device sold that is adapted to be connected to other devices on a network has an Network Interface Card (NIC) with a unique Media Address Code (MAC) that is hardwired into the NIC and cannot be changed. ARP is capable of translating an IP address to a MAC address; the Dynamic Host Configuration Protocol (DHCP) performs the reverse, that is, given a MAC address, the service can identify the IP address of the device. Importantly, the IP protocol and service also includes a Mobile IP protocol that allows a mobile computer, such as a laptop, to be connected from any location while having the same IP address.

Above the IP layer in the TCP/IP protocol stack is the TCP layer that performs a number of functions that do not directly affect the present invention. Above the TCP layer, is the Application layer protocol, service and application. It is in this layer that the Domain Name Service (DNS) is located. Its utility is obvious. An IP address under the IPv6 address scheme may read: 2001:db8:1f70:6e8. The more familiar IP address number uses the IPv4, for example, 184.166.59.43. If every device that a user desired to access on the Internet required the user to remember that address, it is not likely that anyone would use the Internet. Humans are more prone to remember addresses if the address is some meaningful string of letters that spell a name, an acronym, or a concatenation of letters that are at least more familiar than a string of numbers. The DNS is often analogized to a phone book where names of persons or businesses known to the system user may be easily found correlated with a phone number. Before describing the DNS, it is important to understand the structure of the IP address and it is simplest to use the IPv4 address that has four fields containing 32 bits, that is, a field consists of the digits between the periods or “dots”, sometimes referred to as “dotted decimal notation”.

The DNS translates or resolves a computer “name” to a TCP/IP address that is unique on the Internet. It is essentially a directory service. Most users of the Internet recognize that a domain has several parts; the name to the right of the second dot is a Top Level Domain (TLD) such as .com, .edu, etc. which are referred to as generic top-level domains (gTLDs). In addition there are country code Top Level Domains (ccTLD) assigned by the International Standards Organization (ISO). The current addressing system of domains is under reconstruction allowing large entities to use a 64 character name as the TLD. The DNS is a distributed database that resides on multiple servers across the Internet.

There are four classes of IP addresses—Class A, for huge networks that may comprise tens of millions of host MAC addresses; Class B which are large, though smaller than the Class A, to accommodate approximately 60,000 hosts, and Class C which is the smallest class, that is, each network may have only 254 hosts though there may be two million separate and independent networks using the IP addressing system. The classes utilize the fields in a different way; a Class A network uses only the first field for the network address and the other three fields for host addresses. A Class C network is just the opposite. However, the class system was greatly modified with the advent of CIDR (Classless Interdomain Domain Routers) routers that have made Class B addresses more or less obsolete. CIDR conserves domain addresses and reduces the load on routers by reducing the size of router tables. It requires an addition to each address for allocating the network portion of the address from the host portion.

In addition to classes, the IP addressing system may be used in either private networks or the public network such as the Internet. The IANA (Internet Assigned Number Authority) has set aside a certain block of IP addresses that may be used in a private network, but these addresses cannot be used on the Internet, except through a router and an Internet Service Provider (ISP). The private network may be connected to the Internet through the ISP, but the ISP must have a unique address for the private network; once a message is received from the ISP it can be distributed to the correct host using private addresses that are assigned by the private network administrator.

To obtain an IP address for a network, it is necessary to first determine if the address will be for a private network or an address on the Internet. The Internet naming authority has assigned a block of addresses for private networks, currently 192.168.0.0 to 192.168.255.255. The system administrator for the private network can assign one of the allocated numbers to each device. Since these numbers are not unique, that is, another private network could use the same set of addresses, the network can be connected to the Internet only by connection through an ISP. The private network may employ the DHCP protocol mentioned above; that software automatically assigns IP addresses to each device.

The private network can be more complex if the system administrator decides to install sub-networks to accommodate a larger number of host devices, or for other reasons such as security, or ease of management. In that event, a network mask will be used to allocate the IP number assigned to the network. Effectively, the administrator borrows some of the host or device portion of the address to create a subnetwork address; the mask sets all of the network address bits to 1 and all of the host address bits to 0. A command to the server that controls the network and subnet directs the server, when routing an address to ignore the zeroes in the host section of the address thereby more quickly directing the message. In fact the creator of the TCP/IP software usually sets a subnet mask default for the different Class networks, for example, setting all three fields of a Class C network to all ones. The network can then, for example, be split into two networks each with 128 unique addresses and its own unique network address.

In a private network with DHCP, the TCP/IP software will automatically assign and keep track of subnetwork IP addresses as well as the subnetwork mask. It does so by utilizing the client-server relationship, the server housing a block of IP addresses that are unassigned and assigning the IP address at the time a host signs on to the private network for a fixed period of time that automatically renews. The existence of a server in this system will facilitate one physical exemplary embodiment of the invention, as will be seen.

Still another way in which to implement a sub-network, is the provision of a Network Address Translator (NAT) that serves as the interface between the private network and the Internet sometimes referred to as network (or IP) masquerading. The NAT is implemented in a router which is part of the private network and is the single interconnection between all of the devices on the private network and the Internet. The router has an assigned IP address; each device message is sent through the router in order to gain or provide access to the Internet. The NAT software translates from the single IP address of the router to the specific device previously assigned a private network address, that is, a static assignment system. Alternatively, the router may assign an address on demand from the host. NAT is simpler than requesting a private network block of addresses. The router may also serve as a DHCP client that houses the Internet IP address from the ISP as described above. The NAT solution is less than perfect because of possible use of the IP address in an application, such as FTP, which may conflict with the NAT that expects the IP address in the IP layer only. Moreover, NAT breaks the IP model of end-to-end connectivity across the Internet and thus introduces complications in communication between hosts.

The interest in NAT in this application stems from the complications in a IP system. As indicated below, a VoIP system typically operates with the UDP transport protocol layer. One complication of this choice of protocol arises from the fact that in addition to translation of an IP address, NAT additionally includes the UDP port number. Furthermore, both IP and UDP include error checksums. These translations in certain applications such as the Session Initiation Protocol (SIP), which supports VoIP communications (see below), contains explicit network addresses within the application layer data. Typically, SIP may use multiple ports to set up a connection and to transmit a voice stream using the RTP protocol as described below. The IP addresses and port numbers are encoded in the payload data and must be known prior to the traversal of NAT. One workaround for this problem is to use STUN as defined in RFC 3489. STUN (Simple Traversal of User Datagram Protocol (UDP) Through Network Address Translators (NATs)) allow NAT clients (e.g., a computer behind a firewall) to set up a VoIP connection to or from a VoIP service provider not located on the local network. The STUN server allows a client to obtain its public address, the identity or type of the NAT, and the Internet side port of the NAT with a particular local port. This information allows the set up of a UDP connection between the client and the VoIP service provider.

It should be understood that the above-described sub-network systems are solely due to the husbandry of IP addresses in IPv4 that is based on 32 bit addresses and thus falls short of address space. IPv6, a 128 bit address system will make most sub-networks unnecessary to conserve addresses; while other benefits of NAT may give it added life and utility, it complicates use of the SIP protocol upon which many VoIP systems are based.

### VoIP

The present invention provides an application for use in or with VoIP systems of various types. As is well known, the most popular VoIP system is Skype which permits registered users to communicate by voice, and other means, with any other registered user at no charge. Skype offers services such as Instant Messaging, file transfer, and videoconferencing. Skype uses a proprietary protocol and its system is peer-to-peer unlike the client-server systems of other VoIP providers. Skype offers a directory service but the registration process allows any user to list a name that is arbitrary, thus calls cannot be authenticated. However, there are other free VoIP software packages available for downloading on the Internet. Like Skype, in any VoIP system, both parties need software from the same vendor in order to communicate because there is no end-to-end standard that presently exists. All that is required to connect to the Skype network is a “softphone” (your computer, laptop, PDA, etc.), a “smartphone” (iPhone, Android, and the like), or other device with a wireless internet browser running the Wireless Application Protocol (WAP).

Generally, VoIP is based on standard-proposed protocols; in addition to UDP and IP, VoIP utilizes: Real-Time Transport Protocol (RTP), an application layer protocol that allows voice and multimedia communication as defined in RFC 1889; Real-Time Control Protocol (RTCP), a compression protocol that facilitates transmission, contains the name of caller and receiver, and is also used for email addressing; and the above-mentioned Session Initiation Protocol (SIP), a protocol that connects parties, monitors the connection, and disconnects sessions. SIP requires that each device has a SIP URI (Uniform Resource Identifier), that is, its SIP address, in effect a user's SIP phone number; a SIP URI is similar in format to an email address using the format sip: [username]@[domain name]: Port. SIP is a proposed standard protocol defined in RFC 3261, a text-based protocol. The SIP URI is defined in RFC 2396. Once SIP establishes the session the actual communication between users utilizes RTP which defines the format for delivering audio and video over the Internet. Each call requires two RTP channels, one for each phone (called the “endpoint” in the RFC) and two RTCP control channels. SIP communicates requests to initiate an action such as “register,” “invite,” and “bye” from phones and gateways. There are a number of permitted responses to a SIP request, similar to HTTP responses. The format of displayed SIP information is similar to an email message. SIP may be extended to other applications such as online games, teleconferencing, videoconferencing, and streaming video. For accessing a PSTN device, the VoIP software includes Master Gateway Control Protocol (MGCP) that converts telephone numbers to IP addresses using a gateway database of matching numbers. Overcoming the security issues in some VoIP systems, there is a nascent standard for RTP, called SRTP, that together with SRTCP provides encryption for voice or other communication traffic and will also provide means for authenticating the party calling.

As noted above, interconnection of a mobile site utilizes the WAP protocol which is standards-based and includes WML (Wireless Markup Language) that provides a secure transmission of information that may be formatted for small screens, as opposed to the HTML markup language, and also requires less bandwidth, an important aspect of costly cell connections. WML identifies its pages as decks of cards, the latter is equivalent to a separate screen that contains text, images, markup, and links to other cards. The deck is transmitted from the server as a single download of the cards; navigation of the cards is controlled by the user and the wireless device software so that a command will access a particular site that provides the desired information. By downloading the entire deck, there is less need for the repetitive downloading of HTML files and thus conserves bandwidth. Once the WAP server receives the card request, it translates the card language to standard HTML and transmits it to the desired site. Upon receipt of the information, the WAP server, actually a gateway, extracts the data and converts it into a source code called bytecode that has been compiled on the computer within the wireless device. The specific source code depends on the type of device, for example, a softphone, an iPhone, or the like. The information is then displayed on the device screen.

Based on the above description of the VoIP system and the use of the UDP protocol used in both private networks and the Internet, the present invention may be described in detail with reference to the following drawings.

### BRIEF DESCRIPTION OF THE DRAWINGS

FIG. 1 is a block diagram showing the method, program product and system for connecting subscribers on a network, such as various servers and devices as well as access to the PSTN;

FIG. 2 is a diagram of the system, method and program product for including an exemplary embodiment of a server utilized in the present invention, a client, and a third party verifier;

FIG. 3 is a block diagram of a method and program for registering a user of the invention;

FIG. 4 is a block diagram of a method and program for creating a profile of a user of the invention;

FIG. 5 is a block diagram of a method and program for managing a plurality of communication techniques based on user profiles;

FIGS. 6 and 7 comprise a single block diagram of a method and program for managing a VoIP service including determination of sender registration and profile.

### DETAILED DESCRIPTION

### Implementation

As will be appreciated by one skilled in the art, aspects of the present invention may be embodied in a system, method and/or computer program. Accordingly, aspects of the present invention may take the form of an entirely hardware embodiment, an entirely software embodiment (including firmware, resident software, micro-code, etc.), or an embodiment combining software and hardware that may all be generally referred to as a “system.” Furthermore, aspects of the present invention may take the form of a computer program embodied in one or more computer readable medium having computer readable program code embodied therein.

Any combination of one or more computer readable medium may be utilized in the invention, such as a computer readable signal medium or a computer readable storage medium. A computer readable storage medium may be, for example but not limited to, an electronic, magnetic, optical, electromagnetic, infrared or semiconductor system or any suitable combination of such system devices. More specifically, although a non-exhaustive list, examples of a computer readable storage medium would include an electrical connection having one or more wires, a portable computer diskette, a hard drive, RAM, ROM, EPROM, Flash memory, an optical fiber, a portable compact disc read-only memory (CD-ROM), an optical storage device, a magnetic storage device, or any suitable combination of the foregoing. In the context of this description, a computer readable storage medium may be any tangible medium that can contain or store for use by or in connection with an instruction execution system.

A computer readable signal medium may include a propagated data signal with computer readable program code embodied therein, for example, in baseband or as part of a carrier wave. Such a propagated signal may take any variety of forms including, but not limited to, electromagnetic, optical, or any suitable combination thereof A computer readable signal medium may be any computer readable medium that is not a computer readable storage medium and that can communicate, propagate, or transport a program for use by or in conjunction with an instruction execution system.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, SmallTalk, C++, or the like or conventional procedural programming languages, such as the C programming language or similar programming languages. The programming code may execute entirely on a central computer, partly on a central computer and remote terminals or computers, as a stand-alone software package, partly on the central computer and partly on a remote computer or entirely on the central computer or server. In the latter scenario, the remote computer or terminal may be connected to the central computer through any type of network, including a local area network (“LAN”) or a wide area network (“WAN”), or the connection may be made to an external computer (for example through the Internet using an Internet Service Provider).

Aspects of the present invention are described below with reference to flow chart illustrations and/or block diagrams of methods, systems and computer program products according to embodiments of the invention. It will be understood that each block of the flow chart illustrations and/or block diagrams and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create structure for implementing the functions/acts specified in the flow chart and/or diagram blocks.

The computer program instructions may also be loaded on to a computer, other programmable data processing apparatus, or other devices to cause a series of operational steps to be performed on the computer, other programmable apparatus or other devices to produce a computer-implemented process such that the instructions would execute on the computer or other programmable apparatus to provide processes for implementing the functions/acts specified in the flow charts and/or diagram blocks.

The flowchart and block diagrams in the figures illustrate the architecture, functionality and operation of possible implementations of systems, methods and computer program products according to various embodiments of the present invention. In this regard, each block in the flowchart may represent a procedure, module, segment, routine or portion of code, which comprises one or more executable instructions for implementing the specified logical function(s). It should also be noted that, in some alternative implementations, the functions or steps noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular terms “a,” “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements and specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and its practical applications, and to enable others of ordinary skill in the art to understand the invention for various embodiments with various modifications as are suited to the particular use contemplated.

### System

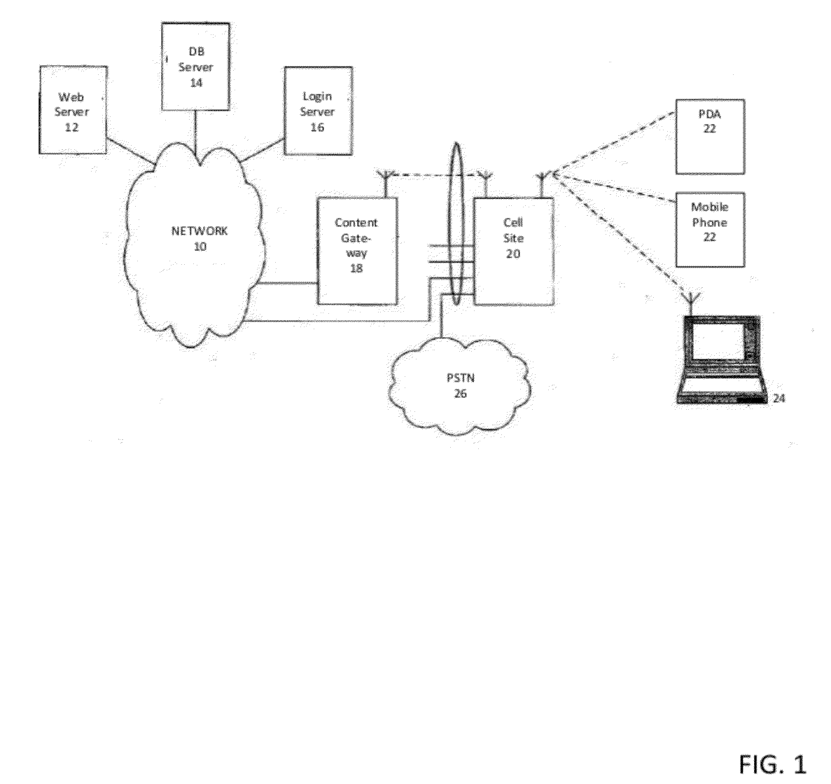

As background there is shown in FIG. 1 a typical network 10 that connects multiple network servers such as a Web (Internet) server 12, a database server 14 and a login server 16. The network provides digital connection for the servers and appropo of the digital voice environment in which the exemplary embodiment of the present invention is implemented may include a gateway 18 that is in wireless communication with a cellular phone site 20 that communicates to mobile devices 22 or stationary device 24, or alternatively, the PSTN 26.

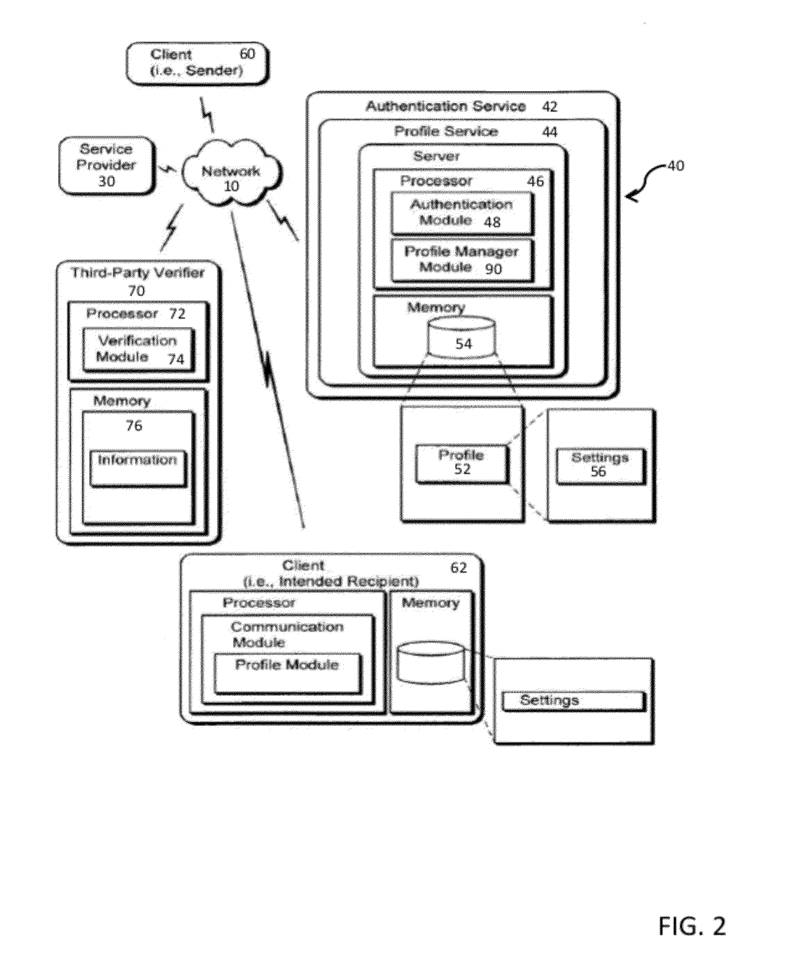

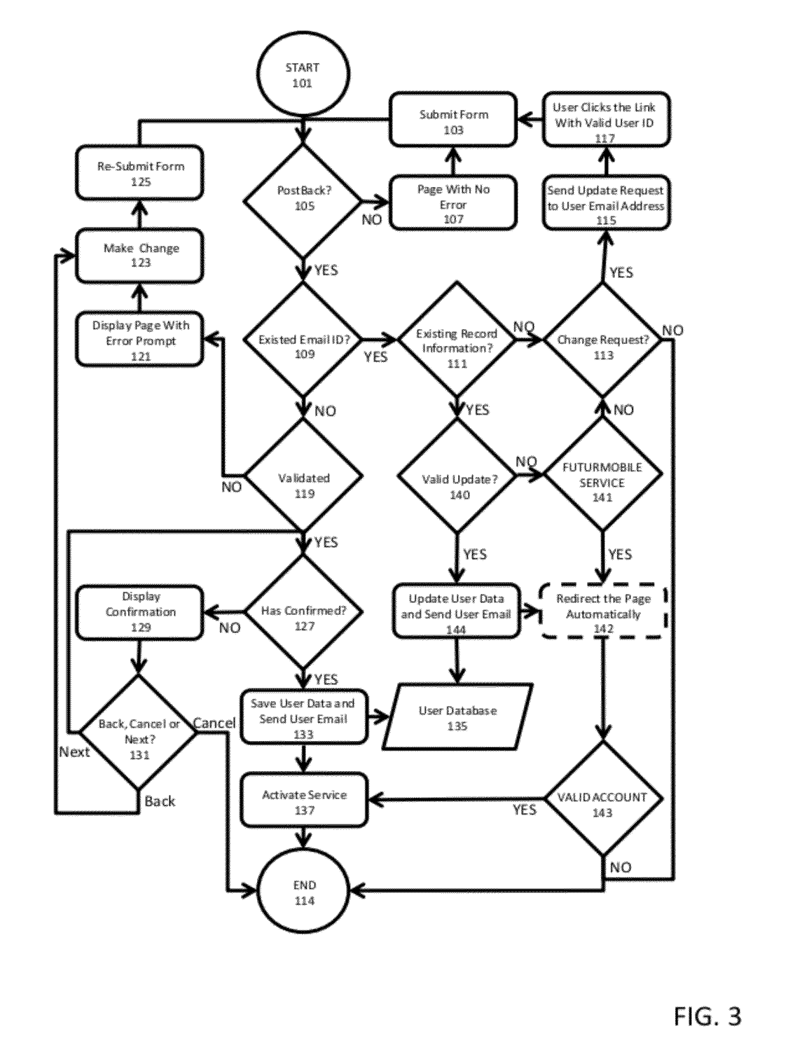

An exemplary embodiment of a system of the present invention is shown in FIG. 2. The embodiment shows the network 10 and an ISP 30 connected to the network. A server with a SIP address, which may comprise an off-the-shelf SIP conference server 40 provides the software product, an authentication service 42 and a profile service 44. The server processor 46 includes at least an authentication module 48 and a profile manager module 50. The profile database 52 resides in memory 54 of the server with all user profiles stored, as shown at 56.

Users of the system such as the client 60, the message sender, is connected to network 10 as is the message recipient client 62. The client 60 includes a processor communication module, profile module and memory. The system may also include a third party verifier host 70 connected to the network 10 comprising a processor 72 with a verification module 74 and a database/memory with client information enabling verification of the SIP request from the client 60.

### Registration

Operation of the system embodiment involves utilization of a software product and the method performed by such product. The method commences at START 101 with a registration process utilizing a form submitted at 103, such as in ASP.NET that includes a postback function 105 for errors in the form; if errors are detected, the process passes to page 107 for correction and the potential registrant is directed to resubmit the form. If postback is successful, the process at 109 determines whether there is an existing email identification of the prospective registrant, and if yes, the process passes to a function 111 to match the form information with the existing record; if no match, the function passes to a change request 113, and if change request is negative, the process ends at 114. If the change requested 113 is positive, the changed address is sent to the user to update the request for the email address at 115. If the existing record information at 111 is positive, function 140 is invoked to determine if there is a valid update to the existing record. If update is not valid, access to service is provided through process 141; if service is denied the user is re-directed back to change request 113; if service is provided, the submit form page is redirected at 142 to a valid account confirmation at 143 and service is activated at 137. If the valid update process at 140 is valid, the update user data process is activated, an email is sent at 144, re-directing the page out process 142 and the user database is simultaneously updated at 135. The user then clicks the link with a valid user ID at 117 which provides submission of the form as in step 103. If there is no existing email identification at 109, the submit form is validated at 119 and if validation fails, the user receives a display page indicating the error prompt at 121. The user then may make a change at routine 123 and resubmit the form at step 125 in which event it reinvokes the postback, determination of an existing email ID, and determines whether it is validated. If the validation process is positive, it is confirmed at step 127; if not confirmed, the failure of confirmation is displayed at 129 and invokes the function at 131 to either cancel, resulting in the end of process at 114, returning or going back to process 123 in which event the subscriber may make a change and resubmit the form at 125. If the function at 131 is successful, it loops back to the confirmation at function 127. Once confirmed at function 127, the information on the submission form is saved as user data at 133 in a user database 135 and service is activated at routine 137.

Once the subscriber is properly registered for the service, the subscriber's universal name as well as the subscriber's email address, his or her mobile name and password, server address and ISP is recorded in the database. A help desk, forum for the group, member profiles and community inclusion becomes available. The user interface includes a menu, tools, option and privacy selection. Service is purchased annually.

### Calling Activity Using Universal Name

Once the user has registered, and has become a subscriber to the system and method providing universal name addressing for digital communication systems, as will be explained with regard to one embodiment, the user is directed to create a profile for the username that has been registered. The user name is unique and is associated with the user's email address and telephone number(s); the system provides translation of such addresses to the user name and vice versa. A single person can register with more than one name for distinct types of activities, such as business and social communications, but the present embodiment will be described in conjunction with a system in which the user has registered a single name. The user is also directed to provide its STUN server and SIP server addresses which are necessary to allow proper connection of users of the service of this embodiment of the invention.

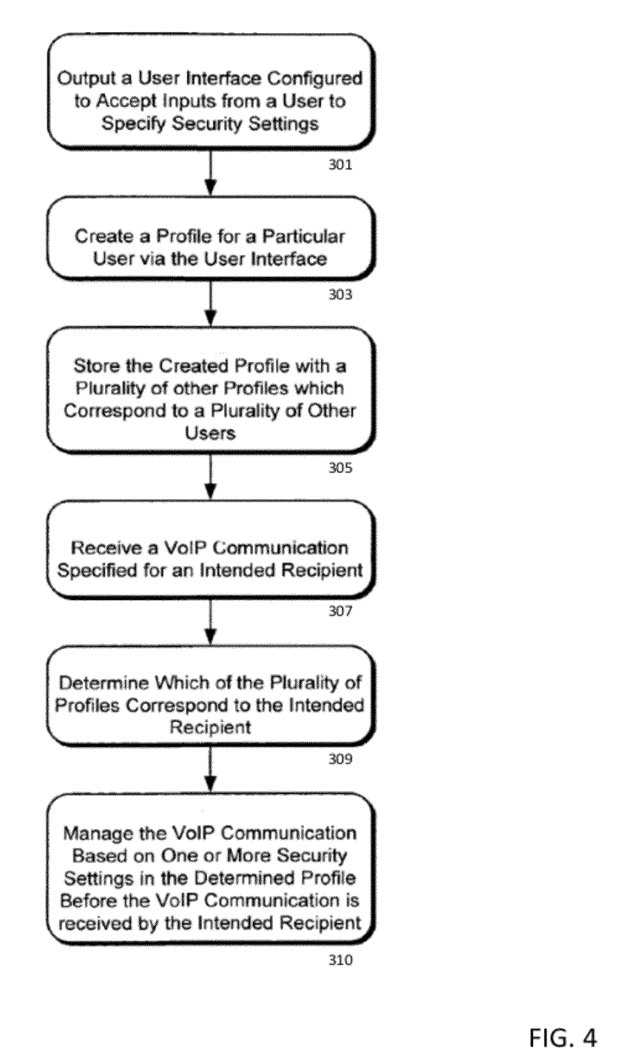

Turning to FIG. 4, a method or process of one embodiment for creating a profile and then handling the subscriber's request for connection comprises a first step 301 in which a SIP-based server transmits a user interface configured to accept user specified security settings to the user's mobile device. The interface that is downloaded from the server prompts the user to select and respond to various queries that will define the profile. One desirable parameter is the selection of a security setting which may be offered at various levels depending upon the use to which the subscriber may employ this embodiment of the method of the present invention. User responses are then transmitted to the main server to create a security profile using the subscriber input at step 303. The profile including the security setting is stored at step 305. If a call is received at the server, addressed to an intended recipient in step 307, a determination of the intended recipient's profile is made at function 309, and accordingly, the VoIP communication at function 310 based on one or more of the security settings in the determined profile prior to allowing the communication to be connected. It will be understood that at various times and for various reasons the user may choose to amend his or her profile in which event the user interface is downloaded to the mobile device upon request at which point the user may then make changes in the profile settings. Of course, the system contemplates that there will be a significant number of users all of whom will provide, once registered as subscribers, a profile so that the main server may include a vast number of names and profiles as may be offered by the entity providing the service and system in accordance with this embodiment of the present invention.

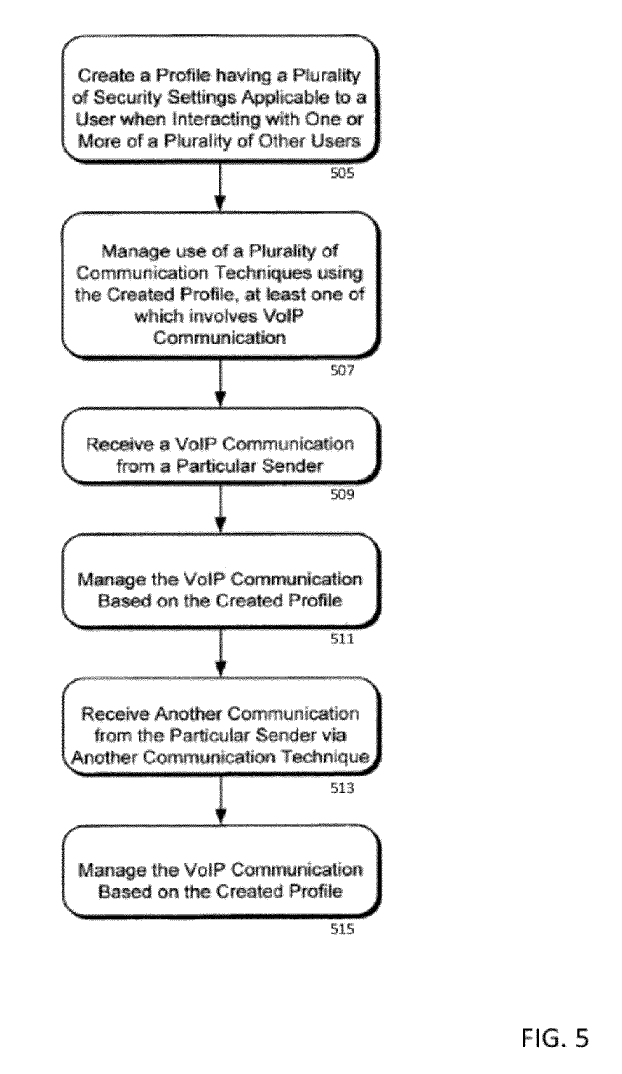

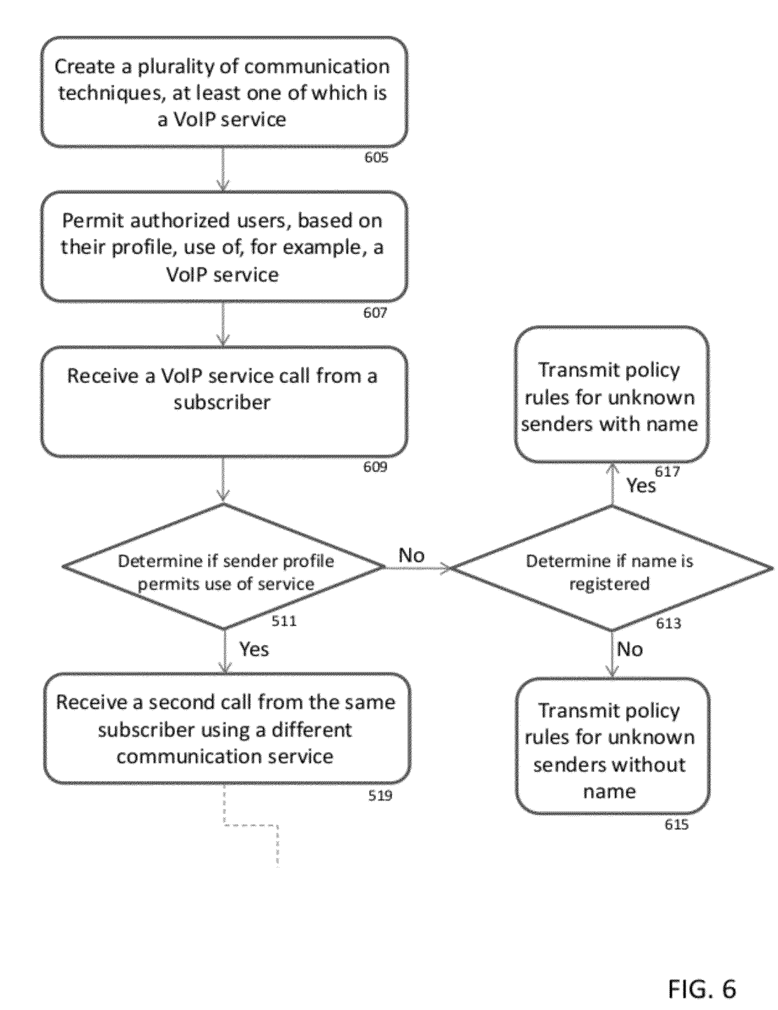

In FIG. 5, the process embodiment commences with the creation of a profile in step 505; the profile has a plurality of security settings applicable to the user when the user is interacting with one or more of a plurality of other users. In step 507, the process manages the plurality of communication techniques using the created profile; at least one of the plurality of communication techniques is a VoIP communication. When a communication from a sender is received at step 509, the communication is managed in step 511 based on the created profile of the sender. In step 513, another communication from that same sender may be received using a different communication technique, for example, IM communication or the like. In step 515 the second communication technique is managed based on the user created profile. Therefore, it will be assumed that a profile may include in addition to security settings, the access to communication techniques other than VoIP.

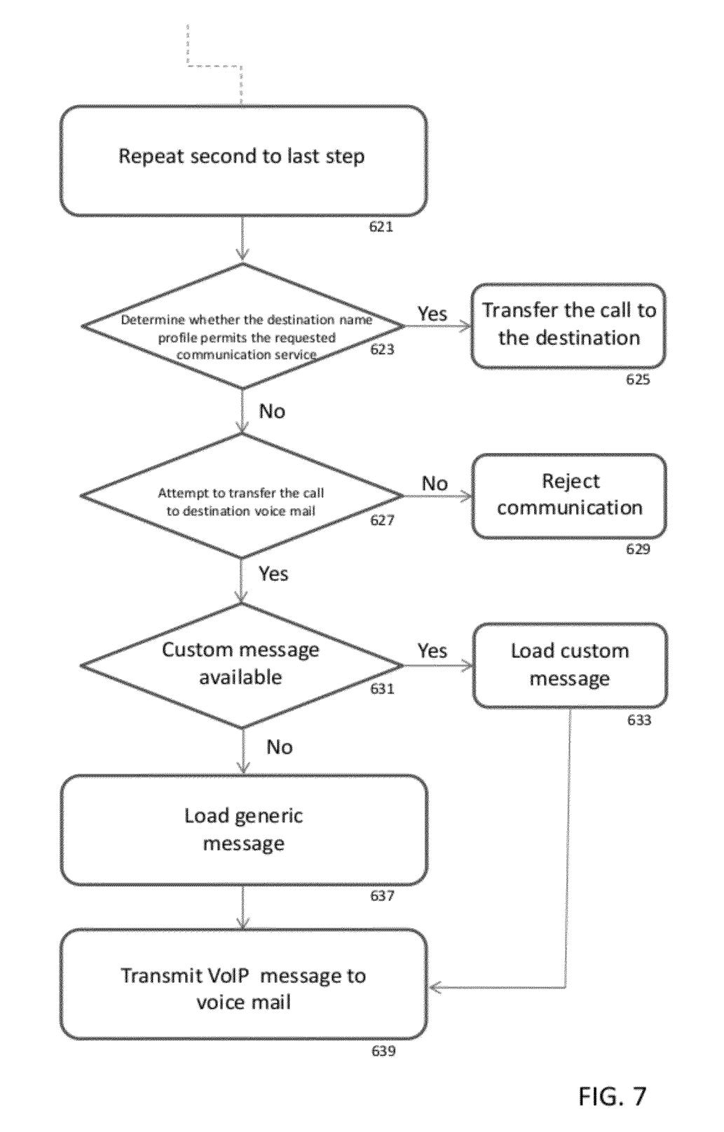

Once a user has registered and has been verified at the commencement of a call, the process of connecting the user with another subscriber proceeds. First, it should be understood that although this embodiment is described with respect to a VoIP service, a variety of services may be offered and a subscriber may, depending upon its profile, utilize services other than voice communications. Such additional services may include, for example, Instant Messaging, multi-media messaging, or file sharing. Therefore, as show in step 605, the server is equipped with the capability of offering a variety of communications services in accordance with the user's profile. In step 607, the name server, upon receipt of a communication request from the user, will determine based on the user's profile, whether that communication technique or method is available, and in this example, the communication technique is the popular VOIP service. In step 609, it is assumed that the user has initiated a service call to the SIP server so as to obtain connection to one or more other subscribers or is seeking access to the PSTN. With respect to the particular call, in step 611, the server will determine if the sender profile permits use of the VoIP service. If no such permission is available based on the user's profile, a NO signal is sent to process 613 where a determination is made as to whether the name has been registered by a subscriber. If no name is found registered, then a NO signal is sent to process 615 which downloads policy rules for unknown senders that do not have a registered name. Conversely, if the name is registered but the profile does not permit the particular service, then a YES signal is sent to another process 617 where policy rules for unknown senders but having a registered name, is transmitted to the user for further action. On the other hand, if in the process of 611 it is determined that the sender profile permits use of the service, then a YES signal is sent to a further process. The flowchart for the embodiment is continued on FIG. 7.

Turning now to FIG. 7, if a second call from the subscriber is received by the server requesting a different communication service, then the process 611 is repeated at step 621, that is, another determination is made to see if based on the user's profile this second communication service is available. Of course, if the user has not requested a second service, then the next steps 619 and 621 are omitted. The YES status in step 611 then passes to the process at 623 to determine whether the destination name, that is, the person called, has a profile that permits the requested communication service. If that determination is positive, then the YES signal is sent to the process at 625. The call is transferred to the destination. That is, the communication connection has been performed, which, according to the present invention, has been accomplished without either party utilizing an internet address, an IP address, or any central connection point in the communication path other than the signaling to establish the connection. Thus, it will be appreciated that the system in the present embodiment supports the universal name method of the present invention. In the event that the destination name profile does not permit the requested communication service, then a NO signal will be sent to another process 627 in which an attempt will be made to transfer the call to the voicemail of the requested communication destination. Essentially, this step determines whether the destination subscriber has presence at the time of the call. If the attempt to transfer the call to the destination is negative, then a NO signal is sent to process 629 at which point the process is terminated and the attempt to communicate is rejected. Conversely, if the signal as a result of the attempt to transfer the call to a destination voicemail is positive, then the process at 631 is invoked to determine whether the sender has input a custom message that is part of the sender's profile which will then be left with the destination user. If a custom message is available, then a YES signal will invoke the process 633, where the custom message will be transmitted to the voicemail of the user as shown on path 635. If in step 631 no custom message is available, then a NO signal will be sent to process 637 where a numeric message, in effect a default message, available to all users, and implemented in the event that no custom message has been established in the profile, is sent. The generic message is then transmitted to the destination voicemail as shown in step 639.

While the specific embodiment described above is based on the present configuration of the Internet and typical intranets, it will be understood by those of ordinary skill in the art that the Internet is an evolving system and that technologies change rapidly and significantly. The registration system and method may be performed in a variety of ways, using different client-server models, protocols, verification of information, sequence of steps, forms and other details. Similarly, while the method of resolving addresses is described for the exemplary embodiment, other methods well-known in the art may be used.

1. A name service for simplifying the connection of users in a wireless digital network comprising the steps of:
registering the user;
creating a record including a user profile of security settings and communication techniques including VoIP; and
managing communications in accordance with the profile.

2. The name service according to claim 1 wherein the registration comprises:
downloading a submission form to the prospective registrant by email to create a record;
determining whether a record including a matching email address exists for the prospective registrant;
if positive, request change in record;
update user record in a database;
send user an acknowledgment; and
activate service.

3. The name service in claim 2 additionally comprising:
determining if a prospective registrant's update to an existing record is valid.

4. The name service in claim 2 additionally comprising:
if the determination of the record is unmatched, that is, negative, validating the prospective registrant to determine if the record contains a valid email address;
if not validated, send message of error in attempt to register;
request correction in registration form; and
accept change in record.

5. The name service in claim 4 additionally comprising:
if validation is positive, save change;
update user record in database; and
activate service.

6. The name service in claim 1 wherein the step of creating a profile comprises:
entry of security setting in the user profile record.

7. The name service in claim 6 wherein the step of creating a profile additionally comprises:
entry of additional security settings at different levels.

8. The name service in claim 6 wherein the step of creating a profile additionally comprises:
entry of selected communication techniques.

9. The name service in claim 8 wherein entry of communication techniques comprises entry of IM messaging technique.

10. The name service in claim 8 wherein entry of communication techniques additionally comprises entry of file sharing technique.

11. The name service in claim 8 wherein entry of communication techniques additionally comprises entry of cellular telephone calls.

12. The name service of claim 1 wherein managing of the communication includes receiving a VoIP communication from a user and managing the communication based on the sender profile.

13. The name service of claim 11 wherein managing of the communication includes determination if a sender profile permits use of a selected service;
if not, determine if the sender name is registered; and
if not registered, transmit policy rules for unknown senders without registered name.

14. The name service of claim 12 wherein managing of the communication includes, if sender name is registered, transmit policy rules for unknown senders with name.

15. A system for providing a universal name service in a digital network, such as the Internet, comprising:
a SIP server having a database for collecting registration of prospective users of the service;
a transmission facility connected to said SIP server;
a computer program executing on said SIP server to transmit a form message to a prospective user soliciting a user selected name;
a receiver facility connected to said SIP server to receive and provide the user selected name to the database;
said computer program soliciting a user selected profile associated with said name;
said receiver facility providing the associated user profile with the name in said database; and
said associated user profile including at least a security setting for any communication techniques provided by said SIP server.

16. The system of claim 15 wherein said user profile includes multiple communication techniques including VoIP.

17. The system of claim 16 wherein said user profile includes various communication techniques including Instant Messaging or Multimedia Messaging.

18. The system of claim 15 wherein said user profile includes multiple security settings for each user.

19. The system of claim 15 wherein said user profile includes multiple security settings for each individual communication technique.

20. A computer program product for managing communications in a system that provides a naming service that translates a user selected name to the user email and telephone addresses, comprising:
registering the user with a selected name;
associating an email address with the user name;
associating a telephone number with the user name;
associating a profile with the user name including at least security settings and communication techniques; and
managing subsequent user use of the system in accordance with the user profile in connecting other users with the user name.
